(19) United States
(12) Patent Application Publication
(10) Pub. No.: US 2025/0012139 A1
(43) Pub. Date: Jan. 9, 2025

(54) Saafety Decives for Doors and Windows

(71) Applicant: Stephen Chester Doucette, Brooklyn (CA)

(72) Inventor: Stephen Chester Doucette, Brooklyn (CA)

(21) Appl. No.: 18/445,317

(22) Filed: Jul. 6, 2023

(51) Int. Cl. E06B 5/11; E05B 17/20; E05B 63/00; E05B 63/14; E05B 65/00; E05B 65/06

(52) U.S. Cl. CPC E06B 5/11; E05B 17/2084; E05B 63/0052; E05B 63/143; E05B 65/0075; E05B 65/06

(57) ABSTRACT

A door safety device for retrofitting a door into a safe-door is provided. The door safety device comprises a reinforcing sheet for being mounted to a door panel of the door. The reinforcing sheet substantially covers the door panel. A cut-out is disposed in the reinforcing sheet for accommodating a door lock cover plate therein. A first portion of at least a safety locking device is mounted to the reinforcing sheet.

### FIELD OF THE INVENTION

The present invention relates to safe-rooms, and more particularly to a door safety device and a window safety device for retrofitting an existing door into a safe-door and an existing window into a safe-window.

### BACKGROUND OF THE INVENTION

A home invasion is a sub-type of burglary in which an offender unlawfully enters into a residence while the occupants are inside with the intent to commit a violent crime against the occupants such as, for example, robbery, assault, rape, murder, or kidnapping. Home invasions are considered especially dangerous by law enforcement because of the potential for a violent confrontation between the occupants and the offender.

In order to minimize harm done to the occupants in the event of a home invasion, safe-rooms, also called panic-rooms, have been installed in some residences. The installation of a safe-room can be the construction of a designated room or the conversion of an existing room. The conversion of an existing room such as, for example, a bedroom, typically involves the replacement of the entrance door and its frame with a protective door such as, for example, a steel door. Unfortunately, the installation of a designated room in an existing residence involves substantial construction work and is most situations prohibitively expensive. The conversion of an existing room by replacing the entrance door and its frame is less expensive, but still involves substantial construction work and might not be feasible when the residence is an apartment or is rented.

Commercially available door reinforcement sets for retrofitting an existing door typically use steel plates mounted to the door covering relatively small areas in proximity to the door lock and the door hinges for reinforcing the weakest points of the door, while still leaving the largest part of the door panel vulnerable to battering inflicted by a violent intruder.

It is desirable to provide a door safety device for retrofitting an existing door into a safe-door.

It is also desirable to provide a door safety device for retrofitting an existing door into a safe-door that substantially reinforces the door panel.

It is also desirable to provide a door safety device for retrofitting an existing door into a safe-door that substantially reinforces the central portion of the door panel.

It is also desirable to provide a door safety device for retrofitting an existing door into a safe-door that is easily installed without removing the door from its frame.

It is also desirable to provide a window safety device for retrofitting an existing window into a safe-window.

### SUMMARY OF THE INVENTION

Accordingly, one object of the present invention is to provide a door safety device for retrofitting an existing door into a safe-door.

Another object of the present invention is to provide a door safety device for retrofitting an existing door into a safe-door that substantially reinforces the door panel.

Another object of the present invention is to provide a door safety device for retrofitting an existing door into a safe-door that substantially reinforces the central portion of the door panel.

Another object of the present invention is to provide a door safety device for retrofitting an existing door into a safe-door that is easily installed without removing the door from its frame.

Another object of the present invention is to provide a window safety device for retrofitting an existing window into a safe-window.

According to one aspect of the present invention, there is provided a door safety device for retrofitting a door into a safe-door. The door safety device comprises a reinforcing sheet for being mounted to a door panel of the door. The reinforcing sheet substantially covers the door panel. A cut-out is disposed in the reinforcing sheet for accommodating a door lock cover plate therein. A first portion of at least a safety locking device is mounted to the reinforcing sheet.

According to the aspect of the present invention, there is provided a door safety device for retrofitting a door into a safe-door. The door safety device comprises a reinforcing sheet for being mounted to a door panel of the door. The reinforcing sheet substantially covers the door panel. A cut-out is disposed in the reinforcing sheet for accommodating a door lock cover plate therein. A first portion of at least a safety locking device is mounted to the reinforcing sheet. Attachment elements are connected to the reinforcing sheet. The attachment elements are oriented perpendicular to the reinforcing sheet. The attachment elements are connected to a top, a left hand side and a right hand side edge of the reinforcing sheet.

According to the aspect of the present invention, there is provided a door safety device for retrofitting a door into a safe-door. The door safety device comprises a reinforcing sheet for being mounted to a door panel of the door. The reinforcing sheet substantially covers the door panel. A cut-out is disposed in the reinforcing sheet for accommodating a door lock cover plate therein. A first portion of at least a safety locking device is mounted to the reinforcing sheet. At least a stiffening element is disposed on the reinforcing sheet. At least one stiffening element is oriented horizontally and at least one stiffening element is oriented vertically or at least one stiffening element is oriented diagonally.

According to the aspect of the present invention, there is provided a door safety device for retrofitting a door into a safe-door. The door safety device comprises a reinforcing sheet for being mounted to a door panel of the door. The reinforcing sheet substantially covers the door panel. A cut-out is disposed in the reinforcing sheet for accommodating a door lock cover plate therein. A first portion of at least a safety locking device is mounted to the reinforcing sheet. A securing brace is mounted to a center portion of the reinforcing sheet. The securing brace when in use is oriented at an angle to the reinforcing sheet for transmitting a force impacting on the door to a floor at a predetermined distance to the door. The securing brace is pivotally movable between a downward position when in use and an upward position when not in use. The securing brace comprises a spring-loaded foot element mounted to a bottom end thereof. A holding element is mounted to the center portion of the reinforcing sheet for holding the securing brace in the upward position when not in use. The securing brace comprises a locking mechanism for locking the same in the downward position.

According to the aspect of the present invention, there is provided a door safety device for retrofitting a door into a safe-door. The door safety device comprises a reinforcing sheet for being mounted to a door panel of the door. The reinforcing sheet substantially covers the door panel. A cut-out is disposed in the reinforcing sheet for accommodating a door lock cover plate therein. A first portion of at least one safety locking device is placed at each of the left hand side, the right hand side, and the top of the reinforcing sheet. A second portion of each of the at least a safety locking device is adapted for being mounted to a frame of the door.

According to one aspect of the present invention, there is provided a door safety device for retrofitting a door into a safe-door. The door safety device comprises a reinforcing sheet for being mounted to a door panel of the door. The reinforcing sheet substantially covers the door panel. A cut-out is disposed in the reinforcing sheet for accommodating a door lock cover plate therein. A first portion of at least a safety locking device is mounted to the reinforcing sheet. A wall reinforcing sheet is mounted to a wall segment adjacent to a frame of the door and a second portion of each of the at least a safety locking device is mounted to the wall reinforcing sheet.

According to the aspect of the present invention, there is provided a method for retrofitting a door into a safe-door. A reinforcing sheet is placed onto a door panel of the door while the door is hinged to its frame such that a door lock cover plate is accommodated in a cut-out disposed in the reinforcing sheet and such that the reinforcing sheet substantially covers the door panel. The reinforcing sheet has a first portion of at least a safety locking device mounted thereto. The reinforcing sheet is fastened to the door panel. A corresponding second portion of the at least a safety locking device is mounted to the frame of the door.

According to the aspect of the present invention, there is provided a method for retrofitting a door into a safe-door. A reinforcing sheet is placed onto a door panel of the door while the door is hinged to its frame such that a door lock cover plate is accommodated in a cut-out disposed in the reinforcing sheet and such that the reinforcing sheet substantially covers the door panel. The reinforcing sheet has a first portion of at least a safety locking device mounted thereto. The reinforcing sheet is fastened to the door panel. A wall reinforcing sheet is mounted to a wall segment adjacent to the frame of the door. The wall reinforcing sheet has a corresponding second portion of each of the at least a safety locking device mounted thereto.

According to another aspect of the present invention, there is provided a window safety device for retrofitting a window into a safe-window. The window safety device comprises a first and a second reinforcing shutter for being hingedly mounted to an inside of a window frame. The reinforcing shutters substantially cover the window. A locking arm is pivotally movable mounted to one of the reinforcing shutters and a locking arm catch is mounted to the other of the reinforcing shutters. The locking arm catch holds the locking arm in the locked position.

The advantage of the present invention is that it provides a door safety device for retrofitting an existing door into a safe-door.

A further advantage of the present invention is that it provides a door safety device for retrofitting an existing door into a safe-door that substantially reinforces the door panel.

A further advantage of the present invention is that it provides a door safety device for retrofitting an existing door into a safe-door that substantially reinforces the central portion of the door panel.

A further advantage of the present invention is that it provides a door safety device for retrofitting an existing door into a safe-door that is easily installed without removing the door from its frame.

A further advantage of the present invention is that it provides a window safety device for retrofitting an existing window into a safe-window.

### BRIEF DESCRIPTION OF THE DRAWINGS

A preferred embodiment of the present invention is described below with reference to the accompanying drawings, in which:

FIG. 1 is a simplified block diagram illustrating in a top view installation of a door safety device according to a preferred embodiment of the invention;

FIGS. 2 to 5 are simplified block diagrams illustrating in a top view, a first side view, a second side view, and a front view, respectively, the door safety device mounted to a door according to the preferred embodiment of the invention;

FIG. 6 is a simplified block diagram illustrating in a front view stiffening elements disposed on the door safety device according to the preferred embodiment of the invention;

FIGS. 7 and 8 are simplified block diagrams illustrating a detail of the stiffening elements of the door safety device according to the preferred embodiment of the invention;

FIG. 9 is a simplified block diagram illustrating in a front view differently arranged stiffening elements disposed on the door safety device according to the preferred embodiment of the invention;

FIGS. 10 and 11 are simplified block diagrams illustrating in a front view and a side view, respectively, an attachment element of the door safety device according to the preferred embodiment of the invention;

FIG. 12 is a simplified block diagram illustrating in a side view a securing brace of the door safety device according to the preferred embodiment of the invention;

FIGS. 13 and 14 are simplified block diagrams illustrating in a side view and a front view a detail of the securing brace of the door safety device according to the preferred embodiment of the invention;

FIGS. 15 and 16 are simplified block diagrams illustrating in a front view wall reinforcing sheets in combination with the door safety device according to the preferred embodiment of the invention; and,

FIG. 17 is a simplified block diagram illustrating in a front view a window safety device according to another preferred embodiment of the invention.

### DESCRIPTION OF THE PREFERRED EMBODIMENT

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

While the description of the preferred embodiments hereinbelow is with reference to a door safety device for being mounted to an in-swing door, it will become evident to those skilled in the art that the embodiments of the invention are not limited thereto, but are also adaptable for for being mounted to an out-swing door. Furthermore, while the description of the preferred embodiments hereinbelow is with reference to a door safety device for being mounted to a door inside a residence, the door safety device may also be employed for retrofitting an entrance door to the residence.

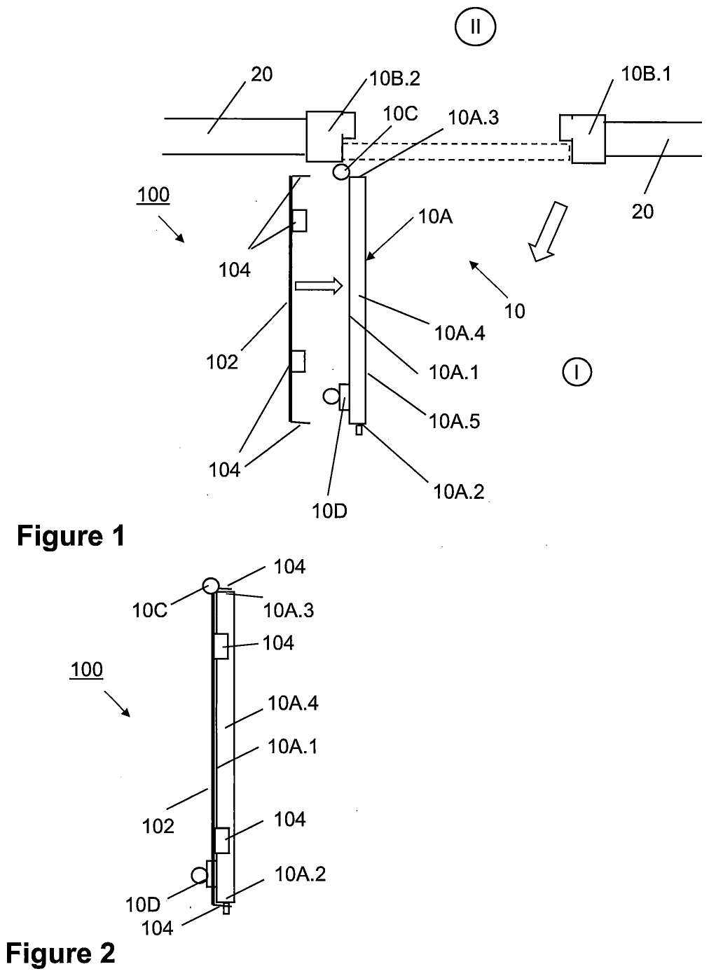

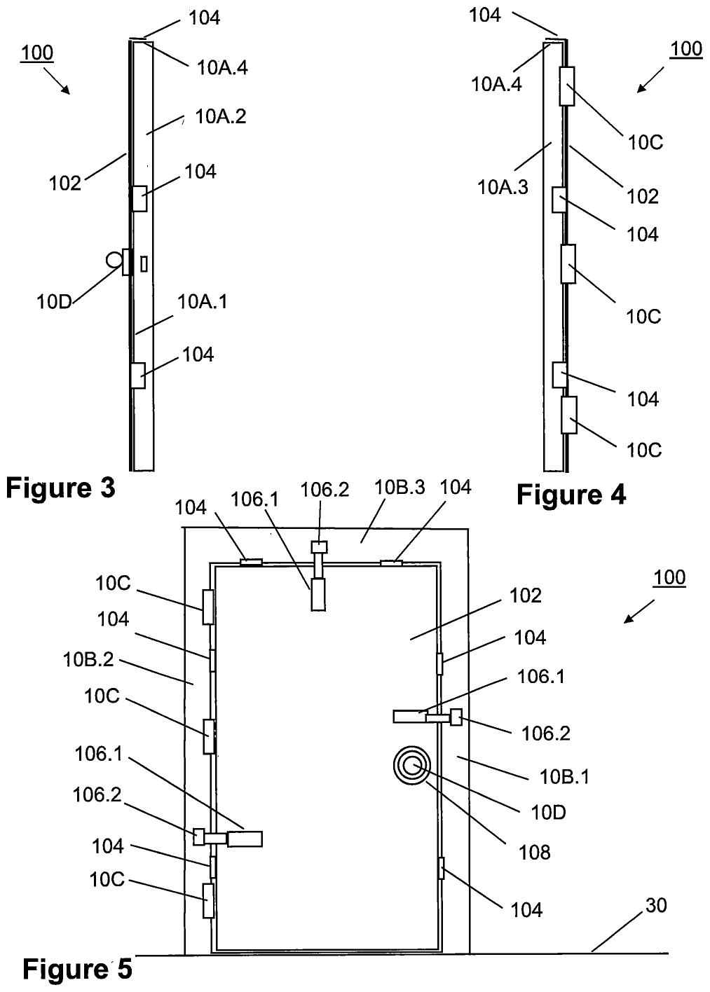

Referring to FIGS. 1 to 16 a door safety device for retrofitting a door into a safe-door 100 according to a preferred embodiment of the invention is provided. FIGS. 1 to 5 illustrate mounting of the door safety device 100 to in-swing door 10, as indicated by the block arrow in FIG. 1, separating room I from room II for converting the room I, for example, a bedroom, into a safe room for protection against an intruder from room II, for example, a hallway. The door 10 comprises door panel 10A mounted to door jamb 10B.2, which is part of the door frame comprising door jambs 10B.1 and 10B.2 connected via header 10B.3 and mounted to wall 20, via hinges 10C. Lock 10D secures the door panel 10A to the door jamb 10B.1 when the door 10 is closed.

The door safety device 100 comprises a reinforcing sheet 102 for being mounted to room I facing surface 10A.1 of the door panel 10A while the door panel remains mounted to the door jamb 10B.2, as indicated by the block arrow in FIG. 1. Preferably, attachment elements 104 are connected to the reinforcing sheet 102 with the attachment elements 104 comprising a sheet mounting portion mounted to the reinforcing sheet 102 and a door mounting portion oriented perpendicular to the reinforcing sheet 102 for being mounted to sides 10A.2, 10A.3, and 10A.4 of the door panel 10A, as illustrated in FIGS. 1 to 4. While in FIGS. 1 to 4 six attachment elements 104 are shown with two attachment elements 104 for each of the sides 10A.2, 10A.3, and 10A.4 of the door panel 10A, it will become evident to one skilled in the art that the door safety device 100 is not limited thereto, but the total number of the attachment elements 104 as well as their placement may vary depending on design preferences. For example, the attachment elements 104 are mounted to the door panel 10A using conventional screw fasteners. The attachment elements 104 enable mounting of the reinforcing sheet 102 to the door panel 10A without leaving blemishes on the room I facing surface 10A.1 after removal. Alternatively, the reinforcing sheet 102 may be directly mounted to the room I facing surface 10A.1.

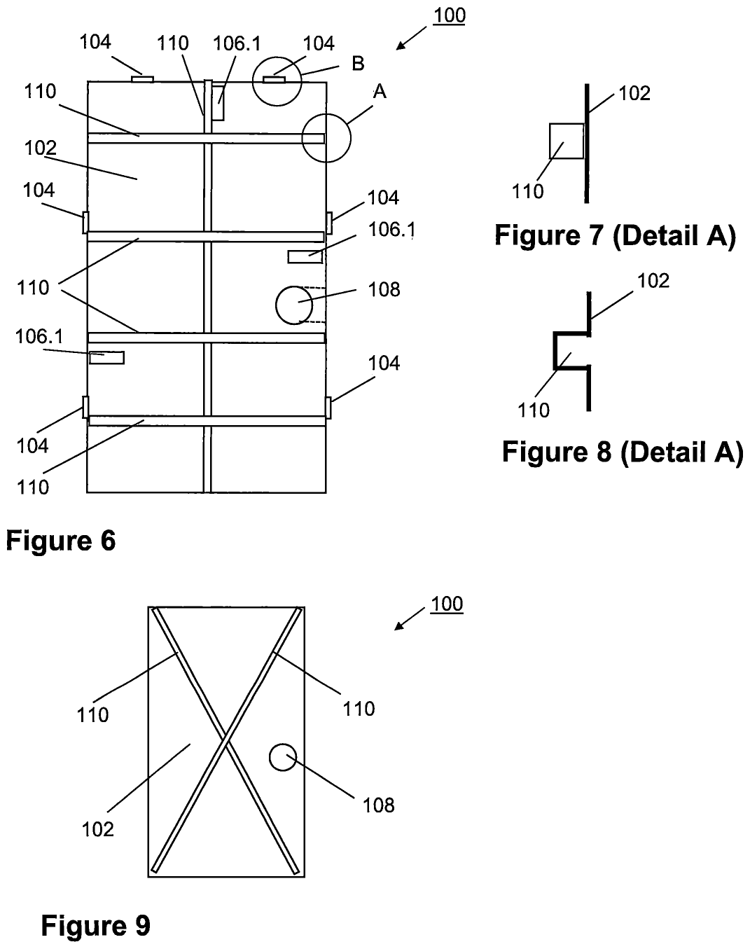

The reinforcing sheet 102 further comprises a cut-out 108 for accommodating a cover plate of the door lock 10D therein. The cut-out 108 may be provided as an aperture inside the reinforcing sheet 102 having various shapes to accommodate differently shaped cover plates. Alternatively, the cut-out 108 may extend to the edge of the reinforcing sheet 102, as indicated by the dashed lines in FIG. 6, to facilitate installation of the reinforcing sheet 102 allowing, for example, in case when the door lock 10D comprises a lever handle instead of a door knob, installation without removing the lever handle.

The reinforcing sheet 102 further comprises a first portion 106.1 of at least a safety locking device 106 mounted thereto, with the safety locking device 106 being, for example, a commercially available barrel bolt safety lock. Of course other locking devices may also be employed. Preferably, the door safety device 100 is provided with more than one safety locking device 106. For example, three safety locking device 106 are provided with the respective first portion mounted to the reinforcing sheet 102 such that they secure the reinforcing sheet 102 to the doorjambs 10B.1, 10B.2 and the header 10B.3, but may be varied depending on design preferences.

The door safety device 100 is easily installed without removing the door panel 10A by placing the reinforcing sheet 102 onto the room I facing surface 10A.1 of the door panel 10A such that a cover plate of the door lock 10D is accommodated in the cut-out 108, as indicated by the block arrow in FIG. 1. After the reinforcing sheet 102 is properly placed on the room I facing surface 10A.1 of the door panel 10A, the attachment elements 104 are fastened to the sides 10A.2, 10A.3, and 10A.4 of the door panel 10A, as illustrated in FIGS. 2 to 4. After the reinforcing sheet 102 is properly mounted to the door panel 10A, the second portions 106.2 of the safety locking devices 106 are mounted to the door frame 10B.1, 10B.2, 10B.3 at locations corresponding to the locations of the respective first portions 106.1 of the safety locking devices 106 mounted to the reinforcing sheet 102, as illustrated in FIG. 5. The second portions 106.2 are mounted to the door frame in a conventional manner using, for example, screw fasteners. Once the second portions 106.2 are mounted to the door frame, the installation of the door safety device 100 is complete.

Preferably, stiffening elements 110 are disposed on the reinforcing sheet 102 for further stiffening the reinforcing sheet 102 to withstand an impact acting on the room II facing surface 10A.5 of the door panel 10A, for example, an intruder kicking the door panel 10A or ramming it with a heavy object used as battering ram, and distributing the impact force to the securing devices 106, as well as to the hinges 10C and the door lock 10D. The stiffening elements 110 may be provided in various numbers and orientations depending on design preferences. For example, the stiffening elements 110 may be oriented horizontally and vertically, as illustrated in FIG. 6, or diagonally, as illustrated in FIG. 9.

For example, the reinforcing sheet 102 is made of a ⅛ inch thick steel sheet which is stiffened by welding stiffening elements 110 made of ¾ inch square steel tubing thereon, as illustrated in the detail in FIG. 7. Alternatively, stiffening elements 110 may be provided by bending the steel sheet, as illustrated in the detail in FIG. 8. The first portion 106.1 of the locking devices is mounted to the reinforcing sheet 102 using, for example, welding or screw fastening. It is noted that employment of a steel sheet as reinforcing sheet 102 also increases the fire resistance of the door to some extent.

Alternatively, steel sheets of different thickness and stiffening elements 110 of different size and shape may be employed depending on design preferences.

Further alternatively, different materials for the reinforcing sheet 102 and the stiffening elements 110 may be employed such as, for example, aluminum, plastic materials, or composite materials, depending on design preferences.

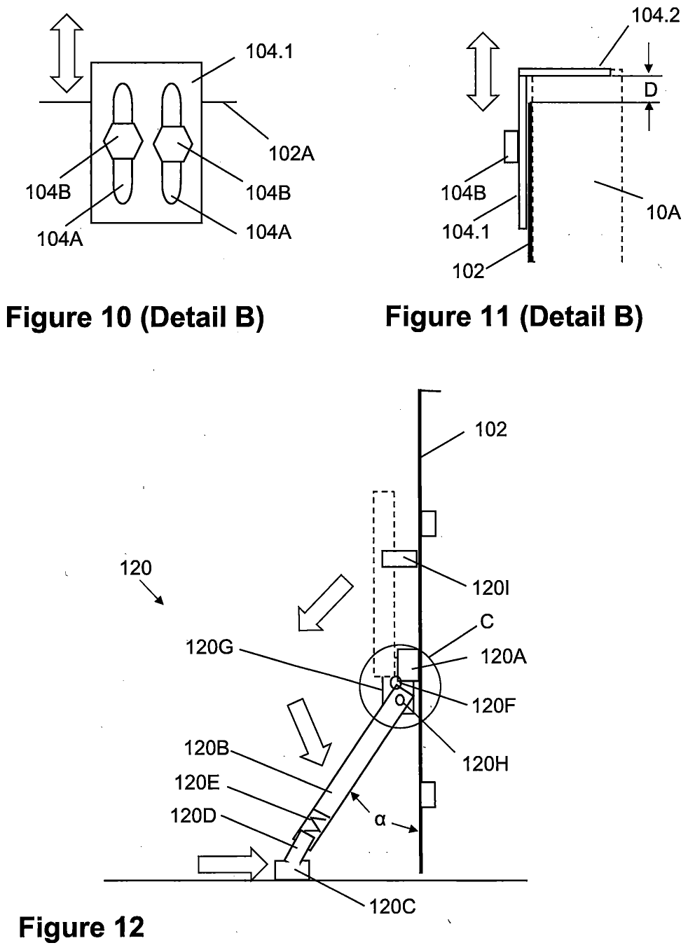

Further preferably, the attachment elements 104 comprise one or more slots 104A disposed in the sheet mounting portion 104.1 for longitudinally movable accommodating a fastener such as, for example, a screw bolt 104B therein for mounting the same to the reinforcing sheet 102, as illustrated in the detail in FIGS. 10 and 11. Employment of the slots 104A enable adjustment of the distance D between the edge of the reinforcing sheet 102 and the door mounting portion 104.2 of the attachment element 104, thus allowing use of standard size reinforcing sheets 102 for different sizes of the door panel 10A, as well as enabling finer adjustment during installation. For example, slots having length between 2 inch and 5 inch are employed enabling use of standard size sheet material for a wide range of door panel 10A sizes by leaving a margin of the surface 10A.1 of the door panel 10A uncovered while still covering a majority of its surface area.

Alternatively, the attachment elements 104 are mounted to the reinforcing sheet 102 using one or more bores disposed in the sheet mounting portion 104.1 for mounting the same in a fixed location. Further alternatively, the attachment elements 104 are welded to the reinforcing sheet 102 or the reinforcing sheet 102 and the attachment elements 104 are made from a same metal sheet with the door mounting portion 104.2 being bent 90°.

Further preferably, the door safety device 100 comprises a securing brace 120 mounted to a center portion of the reinforcing sheet 120, as illustrated in FIG. 12. When in use, the securing brace 120 is oriented at an angle α to the reinforcing sheet 102 for transmitting a force impacting on the door panel 10A to floor 30 at a predetermined distance to the door panel 10A. The securing brace 120 comprises a mounting element 120A mounted to the reinforcing sheet 102 using, for example, screw fastening or welding. Leg element 120B is pivotally movable mounted to the mounting element 120A via hinge 120F. The mounting element 120A and the leg element 120B are made of, for example, ¾ inch square steel tubing. Foot element 120C made of a non-marking, high friction material such as, for example, rubber, is longitudinal movable mounted to the leg element 120B via telescopic element 120D and is spring loaded using, for example, compression spring 120E disposed between the telescopic element 120D and an abutment in the leg element 120B. The leg element 120B is pivotally movable between an upward position, indicated by dashed lines in FIG. 12, when not in use, and a downward position when in use, as indicated by block arrows in FIG. 12.

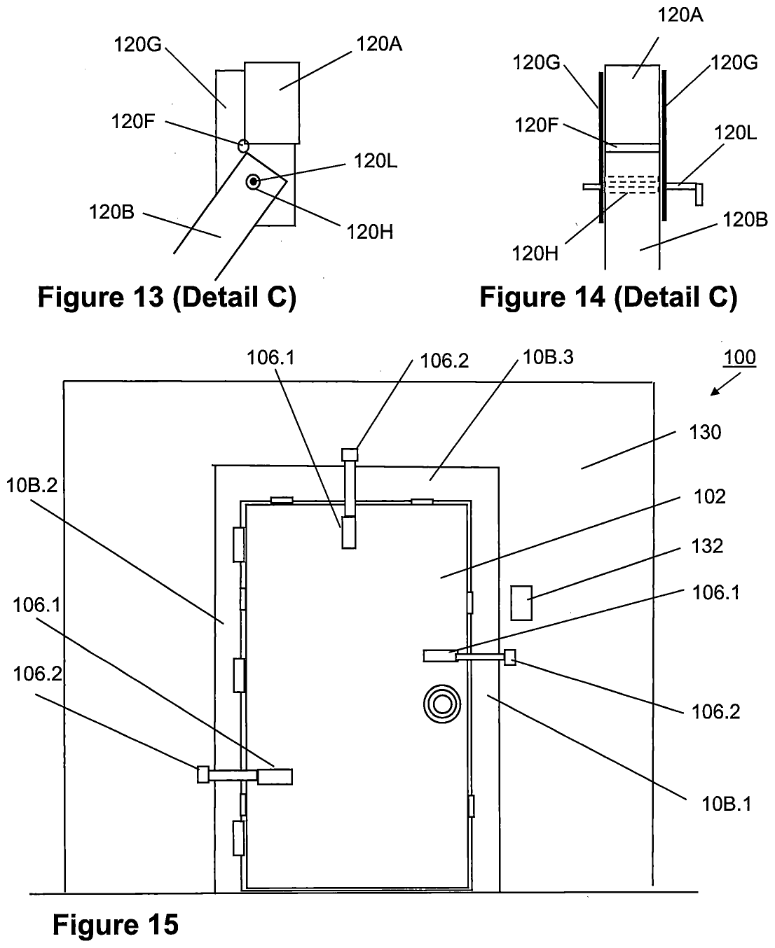

The securing brace 120 further comprises a locking mechanism for locking the leg element 120B in the downward position. For example, the locking mechanism is provided using two mounting plates 120G mounted to the mounting element 120A, as illustrated in the detail in FIGS. 13 and 14, with the two mounting plates 120G having coaxial bores 120H disposed therein. The mounting plates are made of, for example, ⅛ inch thick steel sheet material and welded to the mounting element 120A. When respective bores disposed in the leg element 120B coincide with the bores 120H in the mounting plates 120G, locking pin 120L is inserted into the bores for locking the leg element 120B in the downward position.

Further preferably, the securing brace 120 comprises holding element 1201 mounted to the center portion of the reinforcing sheet 102 for holding the securing brace 120 in the upward position when not in use. For example, employment of ball catches, roller catches, or magnets for holding the securing brace 120 in the upward position enables quick and easy removal of the leg element 120B from the holding element 1201.

The leg element 120B is easily moved from the holding element 1201 into the downward position and locked. First, the leg element 120B is removed from the holding element 1201. Second, the leg element 120B is pivotally moved into the downward position until the foot element 120C touches the floor 30, as indicated by the block arrows in FIG. 12. Third, using one's foot the foot element 120C is pushed towards the door until the locking pin 120L can be inserted.

Optionally, wall reinforcing sheet 130 is provided for being mounted to a segment of the wall 20 adjacent to the door frame 10B.1, 10B.2, 10B.3 of the door. For example, the wall reinforcing sheet 130 covers a segment of the wall 20 surrounding the door frame 10B.1, 10B.2, 10B.3, as illustrated in FIG. 15. The wall reinforcing sheet 130 has the second portion 106.2 of each of the safety locking devices 106 mounted thereto at locations corresponding to the locations of the respective first portions 106.1 mounted to the reinforcing sheet 102. The wall reinforcing sheet 130 further comprises cut-out 132 for accommodating a light switch therein. The wall reinforcing sheet 130 is made of, for example, ⅛ inch thick steel sheet material and is mounted to the wall 20 at locations corresponding to wall studs using screw fasteners.

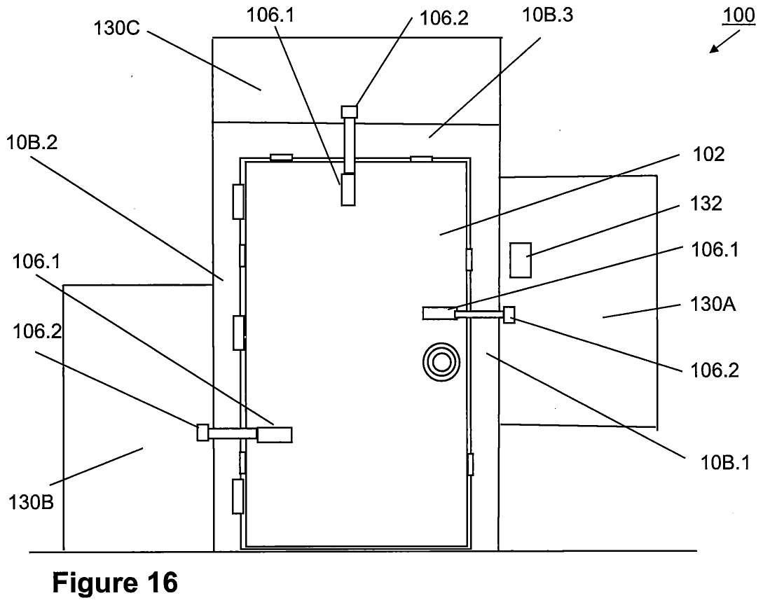

Alternatively, one or more, depending on the number of safety locking devices 106, smaller wall reinforcing sheets 130A, 130B, and 130C are provided to cover smaller segments of the wall at locations corresponding to the locations of the respective first portions 106.1 of the safety locking devices 106 mounted to the reinforcing sheet 102, as illustrated in FIG. 16. Each of the wall reinforcing sheets 130A, 130B, and 130C has the second portion 106.2 of the safety locking devices 106 mounted thereto.

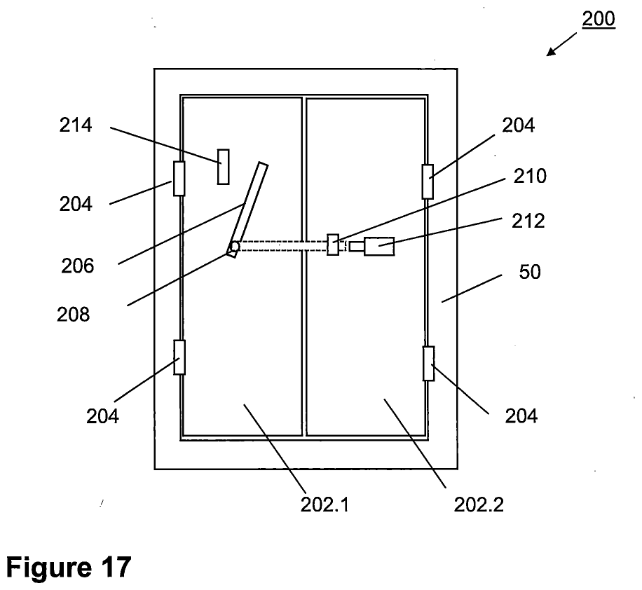

Referring to FIG. 17 a window safety device 200 for retrofitting a window into a safe-window according to a preferred embodiment of the invention is provided. The window safety device 200 comprises two reinforcing shutters 202.1, 202.2 mounted to the inside of window frame 50 via hinges 204. Locking arm 206 is pivotally movable mounted at pivot 208, for example, to reinforcing shutter 202.1 while locking arm catch 210 is mounted to the other reinforcing shutter 202.2. For securing the locking arm 206 in the locking position, securing device 212 such as, for example, a commercially available barrel bolt is mounted to the reinforcing shutter 202.2 to interact with an interacting element such as, for example, a notch or indentation, disposed in the locking arm 206. Of course, other means for securing the locking arm may be employed. In the open-position, the locking arm 206 is secured using holding element 214 mounted to the reinforcing shutter 202.1. For example, employment of ball catches, roller catches, or a magnet enable quick and easy removal of the locking arm 206 from the holding element 214.

For example, the reinforcing shutters 202.1, 202.2 are made of ⅛ inch thick steel sheets while the locking arm 206 is made of ¾ inch square steel tubing or sufficiently thick steel flatware. Alternatively, steel sheets of different thickness may be employed depending on design preferences. Further alternatively, different materials for the reinforcing shutters 202.1, 202.2 and the locking arm 206 may be employed such as, for example, aluminum, plastic materials, or composite materials, depending on design preferences.

As is evident to one skilled in the art, there are numerous means available for decorating the room facing surfaces of the door safety device 100 and the window safety device 200 for the same to have an aesthetically appealing appearance.

The present invention has been described herein with regard to preferred embodiments. However, it will be obvious to persons skilled in the art that a number of variations and modifications can be made without departing from the scope of the invention as described herein.

The embodiments of the invention in which an exclusive property or privilege is claimed are defined as follows:

1. A door safety device for retrofitting a door into a safe-door comprising:
a reinforcing sheet for being mounted to a door panel of the door, the reinforcing sheet substantially covering the door panel;
a cut-out disposed in the reinforcing sheet for accommodating a door lock cover plate therein;
and,
a first portion of at least a safety locking device mounted to the reinforcing sheet.

2. The door safety device according to claim 1 comprising attachment elements connected to the reinforcing sheet, the attachment elements being oriented perpendicular to the reinforcing sheet.

3. The door safety device according to claim 2 wherein the attachment elements are connected to a top, a left hand side and a right hand side edge of the reinforcing sheet.

4. The door safety device according to claim 1 comprising at least a stiffening element disposed on the reinforcing sheet.

5. The door safety device according to claim 4 wherein at least one stiffening element is oriented horizontally and at least one stiffening element is oriented vertically.

6. The door safety device according to claim 4 wherein at least one stiffening element is oriented diagonally.

7. The door safety device according to claim 1 comprising a securing brace mounted to a center portion of the reinforcing sheet, the securing brace when in use being oriented at a predetermined angle to the reinforcing sheet for transmitting a force impacting on the door to a floor at a predetermined distance to the door.

8. The door safety device according to claim 7 wherein the securing brace is pivotally movable between a downward position when in use and an upward position when not in use.

9. The door safety device according to claim 8 wherein the securing brace comprises a spring-loaded foot element mounted to a bottom end thereof.

10. The door safety device according to claim 8 comprising a holding element mounted to the center portion of the reinforcing sheet for holding the securing brace in the upward position when not in use.

11. The door safety device according to claim 9 wherein the securing brace comprises a locking mechanism for locking the same in the downward position.

12. The door safety device according to claim 1 wherein a first portion of at least one safety locking device is placed at each of the left hand side and the right hand side of the reinforcing sheet.

13. The door safety device according to claim 12 wherein a first portion of at least one safety locking device is placed at a top of the reinforcing sheet.

14. The door safety device according to claim 1 wherein a second portion of each of the at least a safety locking device is adapted for being mounted to a frame of the door.

15. The door safety device according to claim 1 comprising a wall reinforcing sheet for being mounted to a wall segment adjacent to a frame of the door and wherein a second portion of each of the at least a safety locking device is mounted to the wall reinforcing sheet.

16. A method for retrofitting a door into a safe-door comprising:
placing a reinforcing sheet onto a door panel of the door while the door is hinged to its frame such that a door lock cover plate is accommodated in a cut-out disposed in the reinforcing sheet and such that the reinforcing sheet substantially covers the door panel, the reinforcing sheet having a first portion of at least a safety locking device mounted thereto; and,
fastening the reinforcing sheet to the door panel.

17. The method according to claim 16 comprising mounting a corresponding second portion of the at least a safety locking device to the frame of the door.

18. The method according to claim 16 comprising mounting a wall reinforcing sheet to a wall segment adjacent to the frame of the door, the wall reinforcing sheet having a corresponding second portion of each of the at least a safety locking device mounted thereto.

19. A window safety device for retrofitting a window into a safe-window comprising:
a first and a second reinforcing shutter for being hingedly mounted to an inside of a window frame, the reinforcing shutters substantially covering the window;
a locking arm pivotally movable mounted to one of the reinforcing shutters; and,
a locking arm catch mounted to the other of the reinforcing shutters, the locking arm catch for holding the locking arm in the locked position.
